(19) United States
(12) Patent Application Publication
(10) Pub. No.: US 2005/0182542 A1
(43) Pub. Date: Aug. 18, 2005

(54) Device and procedure for a steering support for vehicles with electromechanical steering system

(75) Inventors: Olaf Kwasny, Salzgitter (DE); Klaus Wahnschaffe, Wolfsburg/Hattorf (DE); Holger Manz, Sickte (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Volkswagen Aktiengesellschaft

(21) Appl. No.: 11/072,615

(22) Filed: Mar. 4, 2005

Related U.S. Application Data
(63) Continuation of application No. PCT/EP03/09289, filed on Aug. 21, 2003.

(30) Foreign Application Priority Data
Sep. 6, 2002 (DE) DE 102 44 070.0

(51) Int. Cl. B62D 5/04

(52) U.S. Cl. 701/41; 180/443

(57) ABSTRACT

In a device and a procedure for a steering support for vehicles with an electromechanical steering system, maneuverable vehicles wheels are connected with a steering device (1) as well as an electric servo motor (2). A support angle and/or a motive support can be obtained through the servo motor (2). The support angle (δ_{K}) and/or the motive support can be formed by a long-term correction value (δ_{LK}) for a long-term correction (41) and/or by a short-term correction value (δ_{KK}) for a short-term correction (42) and the long-term correction (41) and/or the short-term correction (42) can be switched on or off, according to the driving situation.

### CROSS REFERENCE TO RELATED APPLICATION

This application is a continuation of copending International Application no. PCT/EP2003/009289 filed Aug. 21, 2003 which designates the United States, and claims priority to German application no. 102 070.0 filed Sep. 6, 2002.

### TECHNICAL FIELD OF THE INVENTION

The present invention relates to a device and a procedure for a steering support for vehicles with an electromechanical steering system.

### DESCRIPTION OF THE RELATED ART

The characteristics of the road or modifications of the vehicle, because of the tire wearing for example, can cause an unbalanced movement of the vehicles in a way that the vehicle will be pulled to one side. The unbalanced movement can be caused by a short distraction occurring while driving or through modifications of the car, which can have long term negative effects on the straight ahead direction. In order to counteract the unbalanced movement of the vehicle the driver must secure the steering for a moment.

Based on DE 697 05 365 T2 there is a correction for the steering angle of a servo-steering system, which serves as a support for the driver while continuing straight with the vehicle. For this purpose, a controller is supplied with a steering angle and a motive steering. the controller determines from this point the necessary valve adjustment to counteract the unbalanced movement. The controller responds to an available steering angle and a motive steering, regardless of the present driving condition.

The invention therefore uses the technical problem as a foundation for creation of a device and a procedure for steering support which will compensate a variable unbalanced response of the vehicle according to the driving condition, for vehicles with an electromechanical steering system.

### SUMMARY OF THE INVENTION

The solution for the problem can be achieved by a device for a steering support for vehicles with electromechanical steering system, wherein maneuverable vehicle wheels are connected with a steering device, which can be influenced by a driver, as well as with an electric servo motor, wherein in at least one arithmetic means the support angle and/or the motive support can be determined and the support angle and/or the motive support can be obtained through the servo motor, wherein the support angle and/or the motive support which can be formed at least by a long-term correction value for a long-term correction and/or by a short-term correction value for a short-term correction, wherein a difference of the angle between a steering angle and a straight ahead position can be determined and a correction value, depending on the difference of the angle, can be determined, and wherein the long-term correction and/or the short-term correction can be switched on or off, depending on the driving condition, wherein the driving condition will be determined in the arithmetic means taking into consideration the steering angle, the speed of the steering angle and/or the speed of the vehicle.

The straight ahead position can be mapped by the long-term correction value. The long-term correction can be deactivated when at least in one component an exceeding of a threshold value of the speed of the steering angle and/or an exceeding of a threshold value of a difference of the angle can be observed during a determined period of time. The correction value of the long-term correction can be determined through an integrator, where an initial value of the integrator will be saved on a memory device, for example an EEPROM. The correction value of the short-term correction can be determined through an integrator, where an initial value of the integrator will be zero and the integrator can be returned to the initial value, depending on the angle support and/or on the speed of the steering angle.

The object can also be achieved by a method for a steering support for vehicles with electromechanical steering system, wherein maneuverable vehicle wheels are connected with a steering device, which can be influenced by a driver, as well as with an electric servo motor, the method comprising the steps of determining in at least one arithmetic unit the support angle and/or the motive support; obtaining the support angle and/or the motive support through the servo motor; forming the angle support and/or the motive support by a long-term correction value for a long-term correction and/or by a short-term correction value for a short-term correction; and determining a difference of the angle between a steering angle and a straight ahead position and determining a correction value, depending on the difference of the angle, wherein the long-term correction and/or the short-term correction can be switched on or off, depending on the driving condition, wherein the driving condition will be determined in the arithmetic unit taking into consideration the steering angle, the speed of the steering angle and/or the speed of the vehicle.

Again, the straight ahead position can be mapped by the long-term correction value. The long-term correction can be deactivated when at least in one component an exceeding of a threshold value of the speed of the steering angle and/or an exceeding of a threshold value of a difference of the angle can be observed during a determined period of time. The correction value of the long-term correction can be determined through an integrator, where an initial value of the integrator will be saved on a memory device, for example an EEPROM. The correction value of the short-term correction can be determined through an integrator, where an initial value of the integrator will be zero and the integrator can be returned to the initial value, depending on the angle support and/or on the speed of the steering angle.

The support angle and/or the motive support will be formed by a long-term correction value for a long-term correction and/or by a short-term correction value for a short-term correction, where a difference between a steering angle and a straight ahead position can be observed. In addition, a correction value depending on the difference of the angle can be observed and the long-term correction and/or the short-term correction can be switched on or off, according to the driving condition. The driving condition can be determined by an arithmetic unit, which will take into consideration the steering angle, the speed of the steering angle and/or the speed of the vehicle. The long-term and short-term corrections serve as the straight ahead position, through which the unbalanced movement of the vehicle can be avoided under various conditions of the edges. The unbalanced movement of the vehicle can be caused for example by an incorrectly calibrated sensor of the steering angle, tire wear or an inclined road. The long-term correction serves to compensate a slippery unbalanced movement. A sudden unbalanced movement should be compensated by a fast correction. The correction value will be determined, i.e. the long-term correction value and the short-term correction value are not constant, but will be automatically adapt to varying conditions. For security reasons a correction regarding a straight ahead position can only be switched on in many vehicles exclusively at slow speeds and only in case of a small variance of the angle, for instance under 10°. When the correction for a straight ahead position is switched on, it can be deactivated once again. The range of operation for a short-term correction is generally shorter than for a long-term correction.

In another form of the embodiments the straight ahead position will be shown through the long-term correction value. An observed long-term correction value reflects a necessary support angle for a straight ahead position. For this reason it can be useful as a measure in analyzing the straight ahead position.

In a preferable form of the embodiments, the long-term correction will be deactivated when the speed of the steering angle exceeds a threshold value and/or when the difference of the angle exceeds a threshold value during a determined period of time. Consequently, a reaction on a strong low-frequent unsteady steering wheel can be avoided as well a long-term correction in prolonged curve.

In a further form of the embodiments, the correction value of the long-term correction will be determined by an integrator, where an initial value of the integrator will be saved, onto an EEPROM. For example, an observed correction value for a straight ahead position, which was determined by a long-term correction, can be saved onto a suitable device, for instance onto an EEPROM and will be available at any time for further driving with the vehicle. Therefore, the saved and/or observed correction value signifies an anticipated value for a steering angle in a straight ahead position. The difference of the angle between the straight ahead position and the steering angle can be registered by the calculation of the difference between the anticipated value and the steering angle. Without an existing imbalance, the correction value will be zero. Through a constant factoring, a correction speed or an observed speed can be adapted during the integration. The correction value is limited by a restriction.

In a further form of the embodiments, the short-term correction value will be registered through an integrator where an initial value of the integrator will be zero, and the integrator, depending on the value of the correction for the straight ahead position and/or of the speed of the steering angle, can be returned to the initial value. For example, a short-term correction is necessary when a transition is made from an inclined street onto a level street. On the other hand, no short-term correction should be made during a driving condition due to an operation on the steering. Such an operation on the steering can be detected through a high angle speed, for instance over 500°/s. For example, driving around a curve can be identified through high correction values. In order to reach an adaptation of the modified condition, which was caused by an operation on the steering and/or after a driving around a curve, the correction value will return to the initial value.

### BRIEF DESCRIPTION OF THE DRAWINGS

The invention will be explained in more detail as follows, based on a chosen example of description. The Figures show:

FIG. 1: a representation of an electromechanical steering system with steering support, and

FIG. 2: a correction for a straight ahead position.

### DETAILED DESCRIPTION OF THE PREFERRED EMBODIMENTS

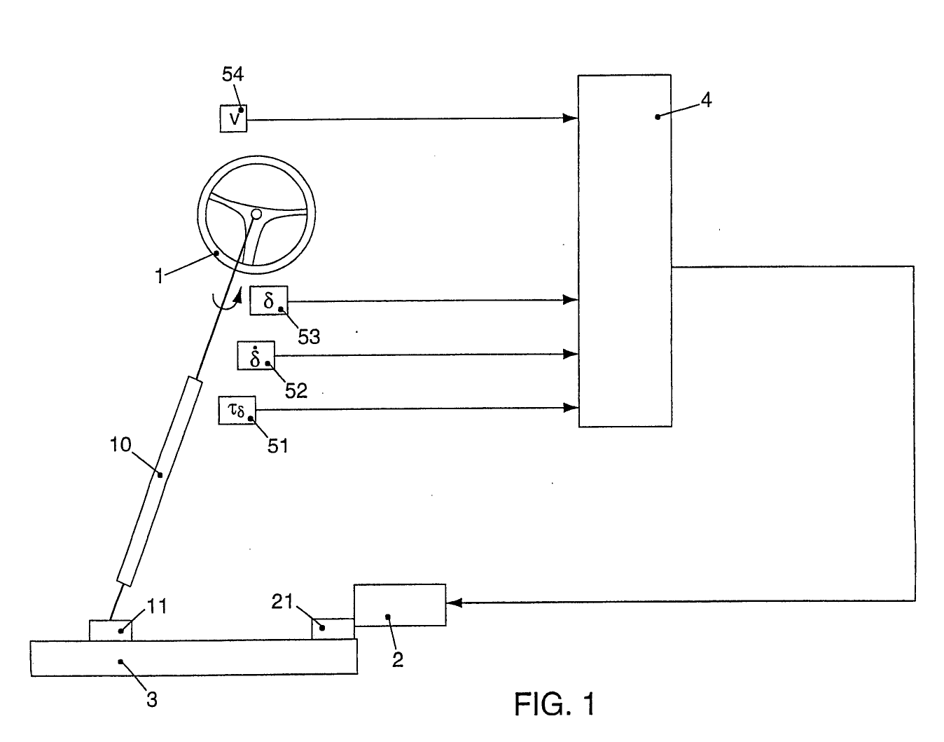

FIG. 1 represents an electromechanical steering system with a steering support, including a steering mechanism 1 characterized as a steering wheel, a servo motor 2, which are connected through a gear 11, 21 with a toothed rack 3. The tooth rack 3 can be controlled through a known steering connection, which is not illustrated here and can also be connected with swiveling wheels of a vehicle, also not illustrated here. The steering mechanism 1 is connected through a torsion bar 10 and the gear 11 with the tooth rack 3. To reach a steering support the servo motor 2 supplies additionally with a motive support, which is determined by an arithmetic unit 4. The motive support will be determined depending on the driving condition of the vehicle. The driving condition can be described by the driving speed v, steering angle δ, speed of the steering angle δ° and motive steering as τ_{δ}. The motive steering τ_{δ} and the speed of the steering angle δ° and the steering angle δ_{.} can be determined by the sensor units 51-53. The driving speed v will be determined through a sensor 54, for example through a speedometer. It is also possible to determine the speed of the steering angle δ° through a deduction from the steering angle δ. All determined values of the driving conditions will be added to the arithmetic unit 4. In the arithmetic unit 4 a motive support will be determined, based on these data, for example a steering support through a correction of a straight ahead position.

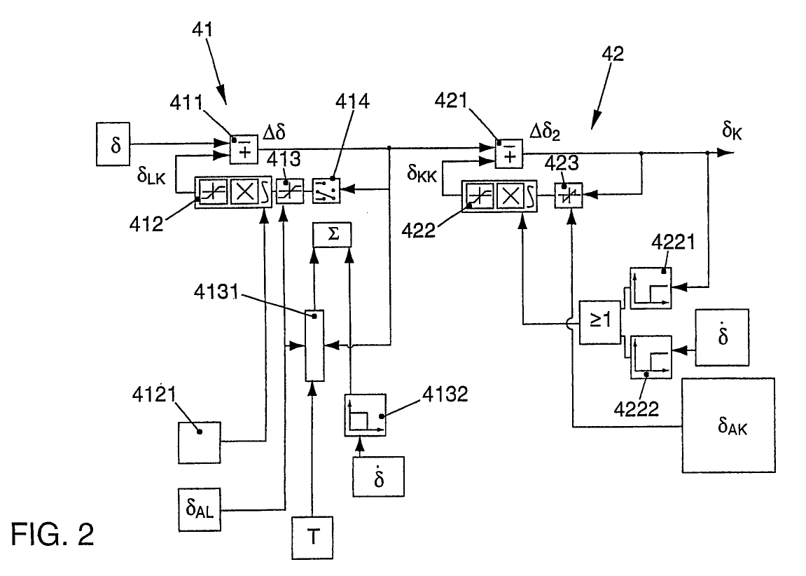

FIG. 2 shows the inquiry of a correction value δ_{K} in the arithmetic unit 4 concerning a straight ahead position, including a long-term correction 41 and a short-term correction 42. The correction for a straight ahead position will only be activated when the speed of the vehicle is low. For example, it could be determined that the speed of the vehicle can not exceed 35 km/h.

The initial value is the steering angle δ. In a component 411 the difference Δδ_{.} between an observed short-term correction value δ_{LK} and the available steering angle δ_{.} will take place. The determined long-term correction value δ_{LK} is also an anticipated value for an available steering angle during a straight ahead position. The long-term correction value δ_{LK} will be learned. The process encloses an integrator 412. The initial value of the integrator 442 is a correction value registered previously. The initial value will be registered onto a memory device 4121, an EEPROM. The inquiry of a long-term correction value δ_{LK} will be deactivated when the speed of the steering angle δ° exceeds a determined range of operation and/or when the difference Δδ exceeds a period of time T, a maximum range of operation δ_{AL} for a long-term correction. The first measure takes into consideration sudden operations in steering due to specific conditions. The second measure will exclude any possibility of distortion of the long-term correction value δ_{LK} due to prolonged curves. By means of a component 413 the long-term correction will be restricted to the range of operation δ_{AL}. A constant factor can alter the anticipated speed, which serves for the acquisition of the long-term correction value δ_{LK} when the integrator 412 is used.

In a component 421 the difference Δδ₂ between the long-term correction value δ_{LK} and a short-term correction value δ_{KK} will be determined for the short-term correction. The short-term correction value δ_{KK} will be obtained by means of an integrator 422, where the initial value for the short-term correction value δ_{KK} will always be zero. The range of operation for a short-term correction is through a component 423 restricted to the range of operation δ_{AK}, although a short-term correction takes place exclusively in this area. The range of operation δ_{AK} for a short-term correction can coincide with the range of operation δ_{AL} for a long-term correction. However, a slower range of operation should be preferred. In a component 4221 the maintenance of a maximum correction value will be monitored. If this is exceeded, the integrator 422 will be returned. A short-term correction should adapt immediately to the driving condition. Therefore, the integrator will be returned after an operation on the steering. An operation on the steering can be detected through the speed of the steering angle δ°. In a component 4222 the exceeding of the maximum value of the speed of the steering angle δ° will be monitored. A motive support can be inferred based on the observed correction value δ_{K}, with which the servo motor will be controlled. However, the correction value can also be reached through an algorithm rule.

It is also possible to observe a motive correction instead of a correction angle. For this purpose, it is possible to consider various conditions, in which at least one integrator 412, 422 will be necessary in order to return the value. For example, due to a sensor of inclination it is possible to detect the transition from an inclined street onto a level street. In addition, some information from a revolution counter or from a navigation system can be used. The components can be executed separately or together and integration is possible regarding technical aspects of a software or hardware.

1. A device for a steering support for vehicles with electromechanical steering system, wherein maneuverable vehicle wheels are connected with a steering device, which can be influenced by a driver, as well as with an electric servo motor, wherein in at least one arithmetic means the support angle and/or the motive support can be determined and the support angle and/or the motive support can be obtained through the servo motor, wherein the support angle and/or the motive support which can be formed at least by a long-term correction value for a long-term correction and/or by a short-term correction value for a short-term correction, wherein a difference of the angle between a steering angle and a straight ahead position can be determined and a correction value, depending on the difference of the angle, can be determined, and wherein the long-term correction and/or the short-term correction can be switched on or off, depending on the driving condition, wherein the driving condition will be determined in the arithmetic means taking into consideration the steering angle, the speed of the steering angle and/or the speed of the vehicle.

2. The device according to claim 1, wherein the straight ahead position can be mapped by the long-term correction value.

3. The device according to claim 1, wherein the long-term correction can be deactivated when at least in one component an exceeding of a threshold value of the speed of the steering angle and/or an exceeding of a threshold value of a difference of the angle can be observed during a determined period of time.

4. The device according to claim 1, wherein the correction value of the long-term correction can be determined through an integrator, where an initial value of the integrator will be saved on a memory device, for example an EEPROM.

5. The device according to claim 1, wherein the correction value of the short-term correction can be determined through an integrator, where an initial value of the integrator will be zero and the integrator can be returned to the initial value, depending on the angle support and/or on the speed of the steering angle.

6. A method for a steering support for vehicles with electromechanical steering system, wherein maneuverable vehicle wheels are connected with a steering device, which can be influenced by a driver, as well as with an electric servo motor, the method comprising the steps of:
determining in at least one arithmetic unit the support angle and/or the motive support;
obtaining the support angle and/or the motive support through the servo motor;
forming the angle support and/or the motive support by a long-term correction value for a long-term correction and/or by a short-term correction value for a short-term correction; and
determining a difference of the angle between a steering angle and a straight ahead position and determining a correction value, depending on the difference of the angle, wherein the long-term correction and/or the short-term correction can be switched on or off, depending on the driving condition, wherein the driving condition will be determined in the arithmetic unit taking into consideration the steering angle, the speed of the steering angle and/or the speed of the vehicle.

7. The method according to claim 6, wherein the straight ahead position can be mapped by the long-term correction value.

8. The method according to claim 6, wherein the long-term correction can be deactivated when at least in one component an exceeding of a threshold value of the speed of the steering angle and/or an exceeding of a threshold value of a difference of the angle can be observed during a determined period of time.

9. The method according to claim 6, wherein the correction value of the long-term correction can be determined through an integrator, where an initial value of the integrator will be saved on a memory device, for example an EEPROM.

10. The method according to claim 6, wherein the correction value of the short-term correction can be determined through an integrator, where an initial value of the integrator will be zero and the integrator can be returned to the initial value, depending on the angle support and/or on the speed of the steering angle.

11. A device for a steering support for vehicles comprising an electromechanical steering system, wherein maneuverable vehicle wheels are connected with a steering device, which can be influenced by a driver, as well as with an electric servo motor, wherein in at least one arithmetic means the support angle and/or the motive support can be determined and the support angle and/or the motive support can be obtained through the servo motor, wherein the support angle and/or the motive support which can be formed at least by a long-term correction value for a long-term correction and/or by a short-term correction value for a short-term correction, wherein a difference of the angle between a steering angle and a straight ahead position can be determined and a correction value, depending on the difference of the angle, can be determined, and wherein the long-term correction and/or the short-term correction can be switched on or off, depending on the driving condition, wherein the driving condition will be determined in the arithmetic means taking into consideration the steering angle, the speed of the steering angle and/or the speed of the vehicle, and wherein the long-term correction can be deactivated when at least in one component an exceeding of a threshold value of the speed of the steering angle and/or an exceeding of a threshold value of a difference of the angle can be observed during a determined period of time.

12. The device according to claim 11, wherein the straight ahead position can be mapped by the long-term correction value.

13. The device according to claim 11, wherein the correction value of the long-term correction can be determined through an integrator, where an initial value of the integrator will be saved on a memory device, for example an EEPROM.

14. The device according to claim 11, wherein the correction value of the short-term correction can be determined through an integrator, where an initial value of the integrator will be zero and the integrator can be returned to the initial value, depending on the angle support and/or on the speed of the steering angle.
